(19) United States
(12) Patent Application Publication
(10) Pub. No.: US 2018/0053031 A1
(43) Pub. Date: Feb. 22, 2018

(54) OPTICAL FINGERPRINT SENSOR PACKAGE

(71) Applicant: TRON INTELLIGENCE INC., Zhubei City (TW)

(72) Inventors: Ruey-Jiann LIN, Zhubei City (TW); Ming-Che HSIEH, Zhubei City (TW)

(21) Appl. No.: 15/481,878

(22) Filed: Apr. 7, 2017

Related U.S. Application Data
(60) Provisional application No. 62/377,779, filed on Aug. 22, 2016.

(51) Int. Cl. G06K 9/00

(52) U.S. Cl. CPC G06K 9/0004

(57) ABSTRACT

An optical fingerprint sensor package includes a carrier, at least one image sensor, at least one LED and at least one non light-transmitting compound. The carrier is provided with pads thereon. The image sensor is mounted on the carrier and electrically connected with the pads. The LED flip-chip is mounted on the carrier through first solder bumps and mounted at an outer side of the image sensor. The non light-transmitting compound surrounds a sidewall of the LED to expose a top surface of the LED.

### REFERENCE TO RELATED APPLICATION

This application is based on Provisional Application Ser. No. 62/377,779, filed 22 Aug. 2016, currently pending.

### BACKGROUND OF THE INVENTION

### Field of the Invention

The present invention relates to a package structure, particularly to an optical fingerprint sensor package.

### Description of the Related Art

Typically, fingerprints have a number of features including ridges, valleys, and finer points. A finer point includes a bifurcation where a ridge is branched and an end point where the ridge ends. The fingerprint can be regarded as a unique biometric data since its characteristic distribution is different every person and two people cannot have the same fingerprints. Thus, the use of biometric data such as fingerprints in a security system may ensure efficient and accurate protection for the district that requires security, movable assets or the like.

A fingerprint recognition apparatus for acquiring an image of the fingerprint may be classified into a semiconductor type apparatus and optical type apparatus, and an optical fingerprint recognition apparatus is widely used rather than a semiconductor fingerprint recognition apparatus.

The optical fingerprint recognition apparatus includes light sources, an image sensor and a total internal reflection prism glass in which light proceeds through the incident surface of the prism, is reflected at the contact surface of the prism, and is emitted from the exit surface of the prism. When a finger is put on the contact surface of the prism, light undergoes diffused reflectance at the points where the ridges of the fingerprint are in contact with the glass. However, no light undergoes the diffused reflectance at the points where the valleys of the fingerprint are in contact with the glass. Thus, the light emitted from the exit surface of the prism exhibits the characteristics of the fingerprint. Nevertheless, since the light sources surround the image sensor on a horizontal plane, the side light of the light sources often interferes with the image sensor to reduce the precision of the image sensor.

To overcome the abovementioned problems, the present invention provides an optical fingerprint sensor package.

### SUMMARY OF THE INVENTION

A primary objective of the present invention is to provide an optical fingerprint sensor package, which uses one non light-transmitting compound to surround a LED and effectively prevents the side light of the LED from interfering with an image sensor in a low-cost manner.

To achieve the abovementioned objectives, the present invention provides an optical fingerprint sensor package. In an embodiment, the optical fingerprint sensor package comprises a carrier, at least one image sensor, at least one LED, at least one non light-transmitting compound and a light-transmitting compound. For example, the carrier is a substrate or a leadframe, and the LED is an infrared (IR) LED. The carrier is provided with pads thereon. The image sensor is flip-chip mounted on the carrier. The LED flip-chip is mounted on the carrier through first solder bumps and mounted at an outer side of the image sensor. The image sensor is electrically connected with the pads through second solder bumps. The non light-transmitting compound surrounds a sidewall of the at least one LED to expose a top surface of the at least one LED. The light-transmitting compound covers the carrier, the pads, the image sensor, the first solder bumps, the second solder bumps and the non light-transmitting compound.

In addition, a top surface of the non light-transmitting compound is higher than that of the LED.

Besides, at least one LED comprises a plurality of LEDs, and the plurality of LEDs is peripherally around the image sensor, and at least one non-transparent compound comprises a plurality of non-transparent compounds, and the plurality of non-transparent compounds respectively surround the plurality of LEDs.

The installation of the image sensor is adaptable. In another embodiment, the image sensor is mounted on the carrier through a die attaching material and electrically connected with the pads by conductive wire bonding. As a result, the light-transmitting compound covers the carrier, the pads, the image sensor, the die attaching material, the first solder bumps and the non light-transmitting compound.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view of an optical fingerprint sensor package according to the first embodiment of the present invention;

FIG. 2 is a top view of the optical fingerprint sensor package according to the first embodiment of the present invention;

FIG. 3 is a sectional view taken along Line A-A′ of FIG. 2;

FIG. 4 is a perspective view of an optical fingerprint sensor package according to the second embodiment of the present invention;

FIG. 5 is a top view of the optical fingerprint sensor package according to the second embodiment of the present invention;

FIG. 6 is a sectional view taken along Line B-B′ of FIG. 5;

FIG. 7 is a perspective view of an optical fingerprint sensor package according to the third embodiment of the present invention;

FIG. 8 is a top view of the optical fingerprint sensor package according to the third embodiment of the present invention;

FIG. 9 is a sectional view taken along Line C-C′ of FIG. 8;

FIG. 10 is a perspective view of an optical fingerprint sensor package according to the fourth embodiment of the present invention;

FIG. 11 is a top view of the optical fingerprint sensor package according to the fourth embodiment of the present invention;

FIG. 12 is a sectional view taken along Line D-D′ of FIG. 11;

FIG. 13 is a perspective view of an optical fingerprint sensor package according to the fifth embodiment of the present invention;

FIG. 14 is a top view of the optical fingerprint sensor package according to the fifth embodiment of the present invention;

FIG. 15 is a sectional view taken along Line E-E′ of FIG. 14;

FIG. 16 is a perspective view of an optical fingerprint sensor package according to the sixth embodiment of the present invention;

FIG. 17 is a top view of the optical fingerprint sensor package according to the sixth embodiment of the present invention;

FIG. 18 is a sectional view taken along Line F-F′ of FIG. 17;

FIG. 19 is a perspective view of an optical fingerprint sensor package according to the seventh embodiment of the present invention;

FIG. 20 is a top view of the optical fingerprint sensor package according to the seventh embodiment of the present invention;

FIG. 21 is a sectional view taken along Line G-G′ of FIG. 20;

FIG. 22 is a perspective view of an optical fingerprint sensor package according to the eighth embodiment of the present invention;

FIG. 23 is a top view of the optical fingerprint sensor package according to the eighth embodiment of the present invention; and

FIG. 24 is a sectional view taken along Line H-H′ of FIG. 23.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

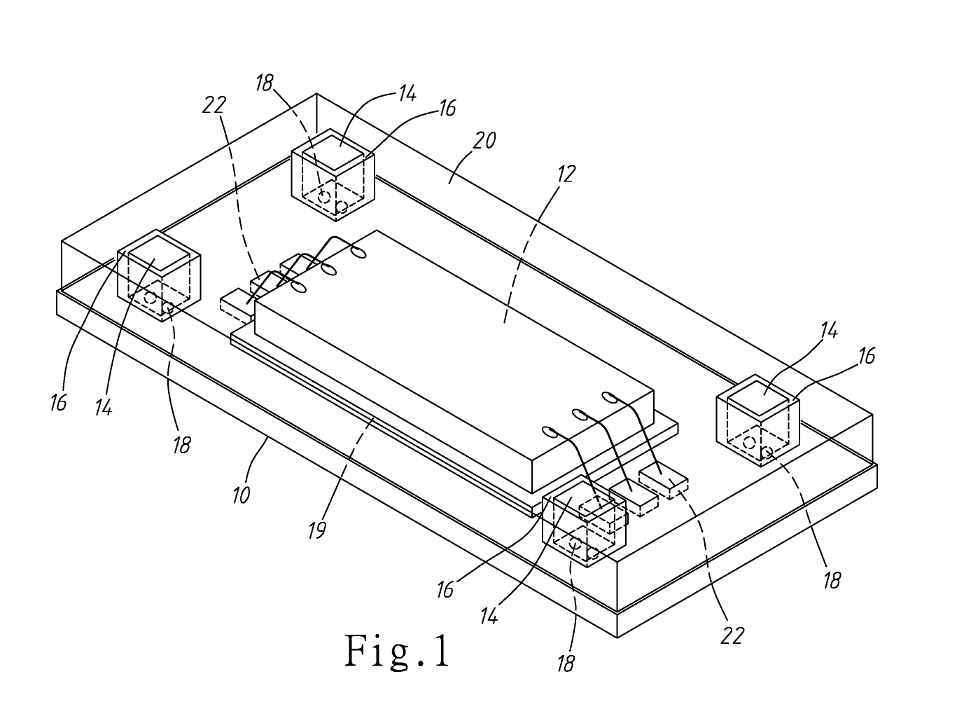

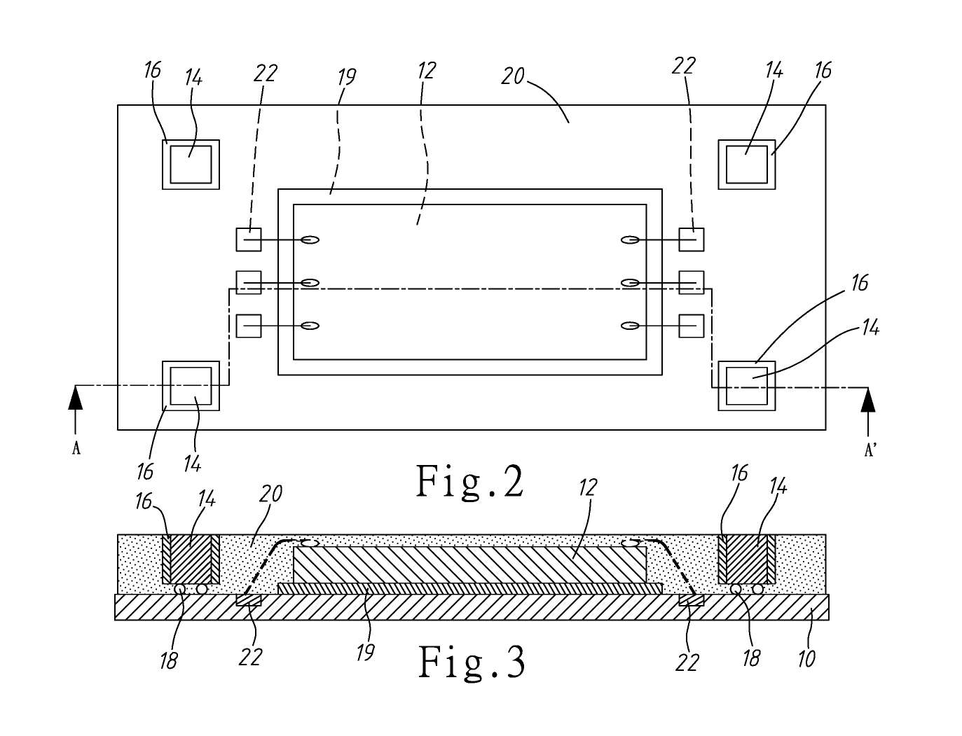

Refer to FIG. 1, FIG. 2 and FIG. 3. The first embodiment of the optical fingerprint sensor package of the present invention is introduced as below. The optical fingerprint sensor package comprises a carrier 10, at least one image sensor 12, at least one LED 14, at least one non light-transmitting compound 16, first solder bumps 18, a die attaching material 19 and a light-transmitting compound 20. For example, the carrier 10 is a substrate or a leadframe, and the LED 14 is an infrared (IR) LED. In the first embodiment, there are one image sensor 12, the plurality of LEDs 14 and the plurality of non light-transmitting compounds 16. The carrier 10 is provided with pads 22 thereon. The image sensor 12 is mounted on the carrier 10 through the die attaching material 19 and electrically connected with the pads 22 by conductive wire bonding. The LEDs 14 flip-chip are mounted on the carrier 10 through the first solder bumps 18 and mounted at an outer side of the image sensor 12. The plurality of LEDs 14 is peripherally around the image sensor 12. The non light-transmitting compounds 16 respectively surround sidewalls of the plurality of LEDs 14 to expose a top surface of each LED 14 and block the side light of each LED 14. Thus, the present invention can effectively prevent the side light of each LED 14 from interfering with the image sensor 12 in a low-cost manner, thereby improving the precision of the image sensor 12. The light-transmitting compound 20 covers the carrier 10, the pads 22, the image sensor 12, the first solder bumps 18, the die attaching material 19 and the non light-transmitting compounds 16.

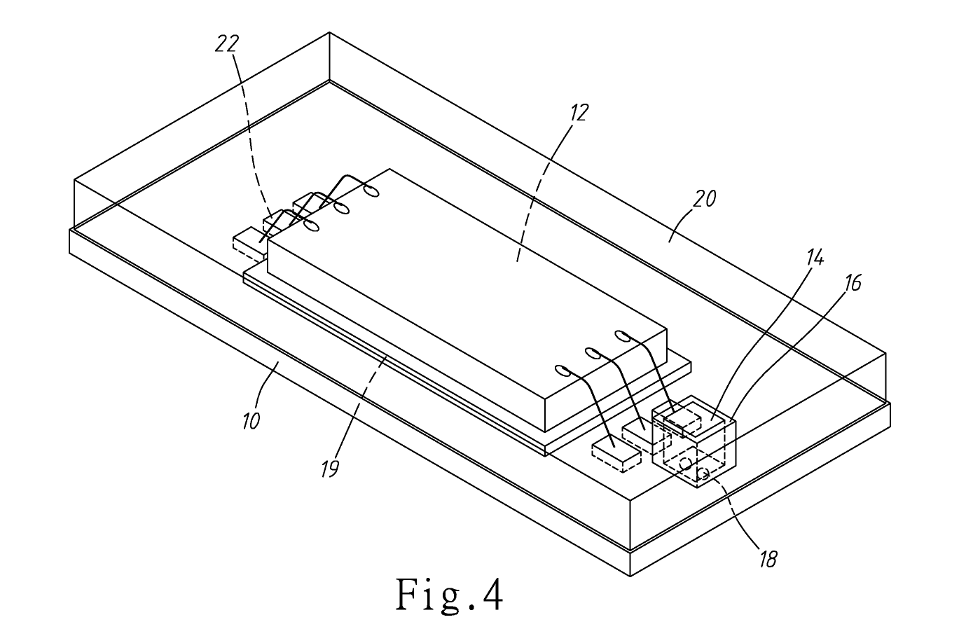

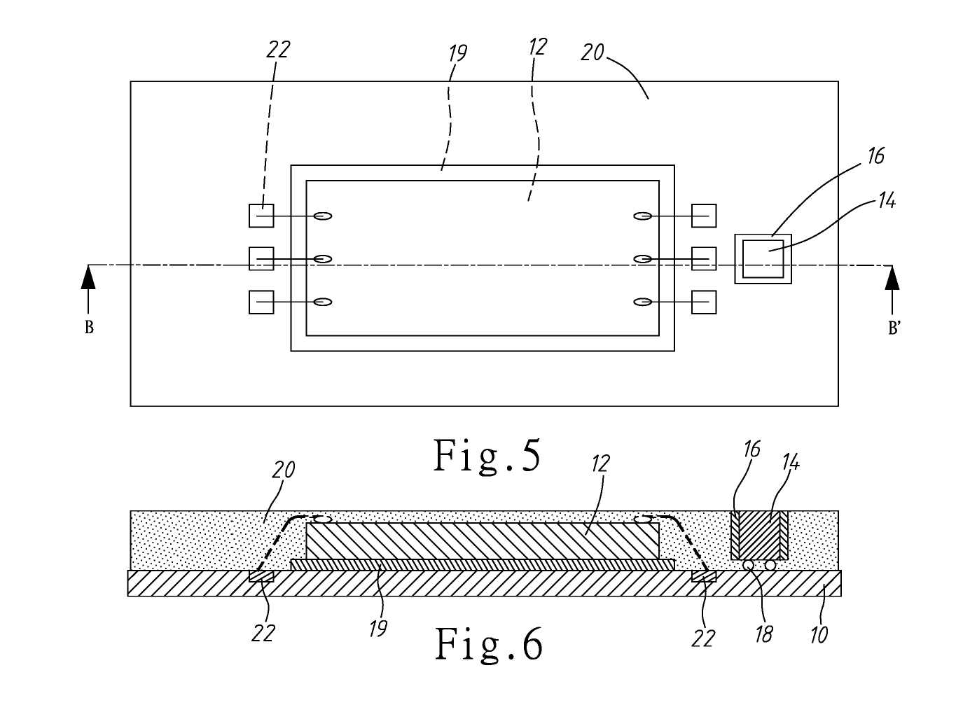

Refer to FIG. 4, FIG. 5 and FIG. 6. The second embodiment of the optical fingerprint sensor package of the present invention is introduced as below. The second embodiment is different from the first embodiment in the amounts of the LED 14 and the non light-transmitting compound 16. In the second embodiment, there are one LED 14 and one non light-transmitting compound 16. Since the non light-transmitting compound 16 surrounds a sidewall of the LED 14 to expose a top surface of the LED 14, the side light of the LED 14 also cannot interfere with the image sensor 12.

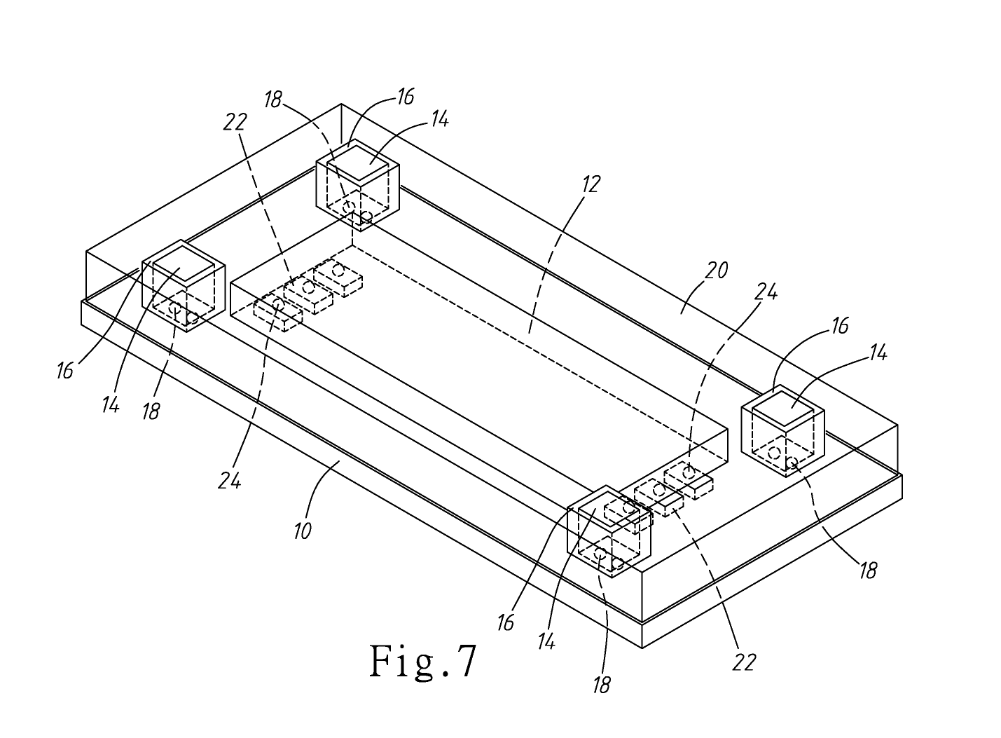

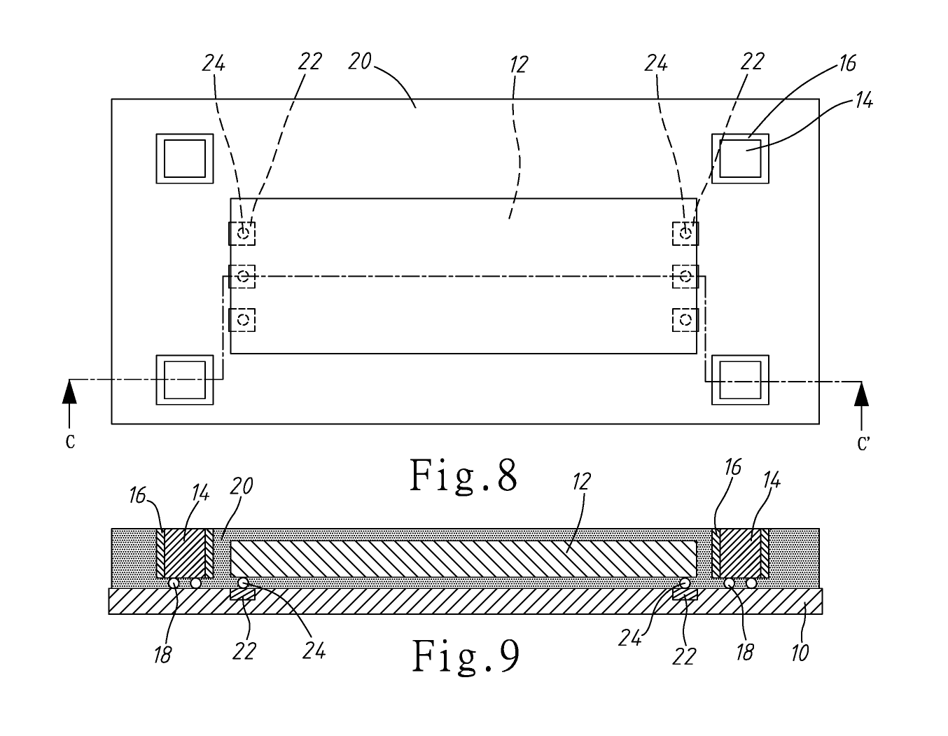

Refer to FIG. 1, FIG. 7, FIG. 8 and FIG. 9. The third embodiment of the optical fingerprint sensor package of the present invention is introduced as below. The third embodiment is different from the first embodiment in the installation of the image sensor 12. In the third embodiment, instead of wire bonding and the die attaching material 19, the image sensor 12 is flip-chip mounted on the carrier 10. The image sensor 12 is electrically connected with the pads 22 through second solder bumps 24. Since the non light-transmitting compounds 16 respectively surround sidewalls of the LEDs 14 to expose a top surface of each LED 14, the side light of the LED 14 also cannot interfere with the image sensor 12.

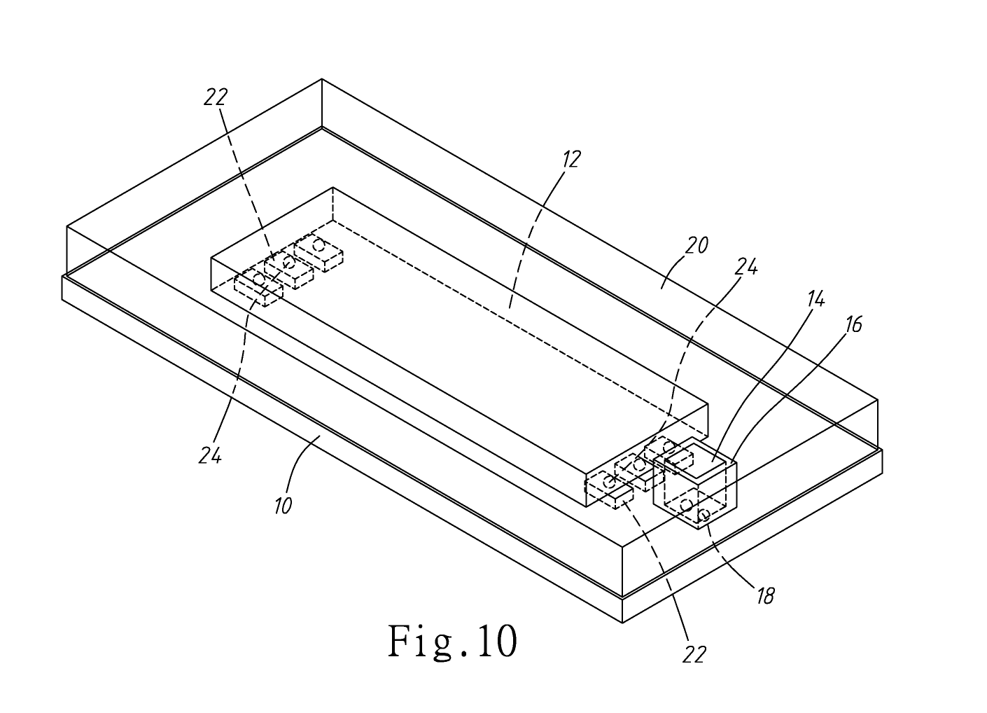

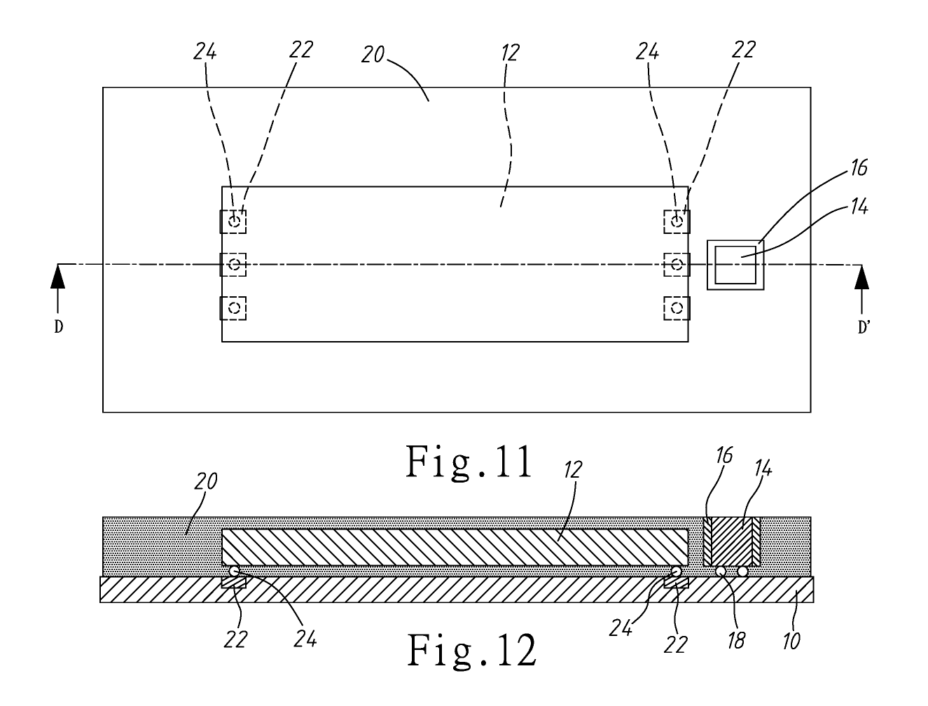

Refer to FIG. 10, FIG. 11 and FIG. 12. The fourth embodiment of the optical fingerprint sensor package of the present invention is introduced as below. The fourth embodiment is different from the third embodiment in the amounts of the LED 14 and the non light-transmitting compound 16. In the fourth embodiment, there are one LED 14 and one non light-transmitting compound 16. Since the non light-transmitting compound 16 surrounds a sidewall of the LED 14 to expose a top surface of the LED 14, the side light of the LED 14 also cannot interfere with the image sensor 12.

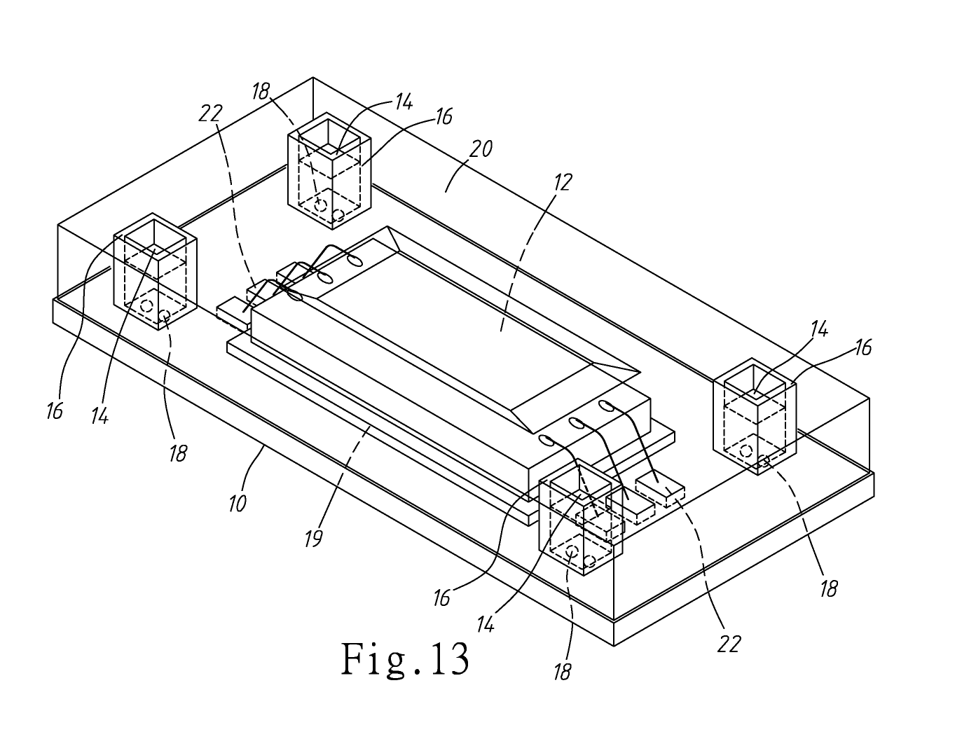

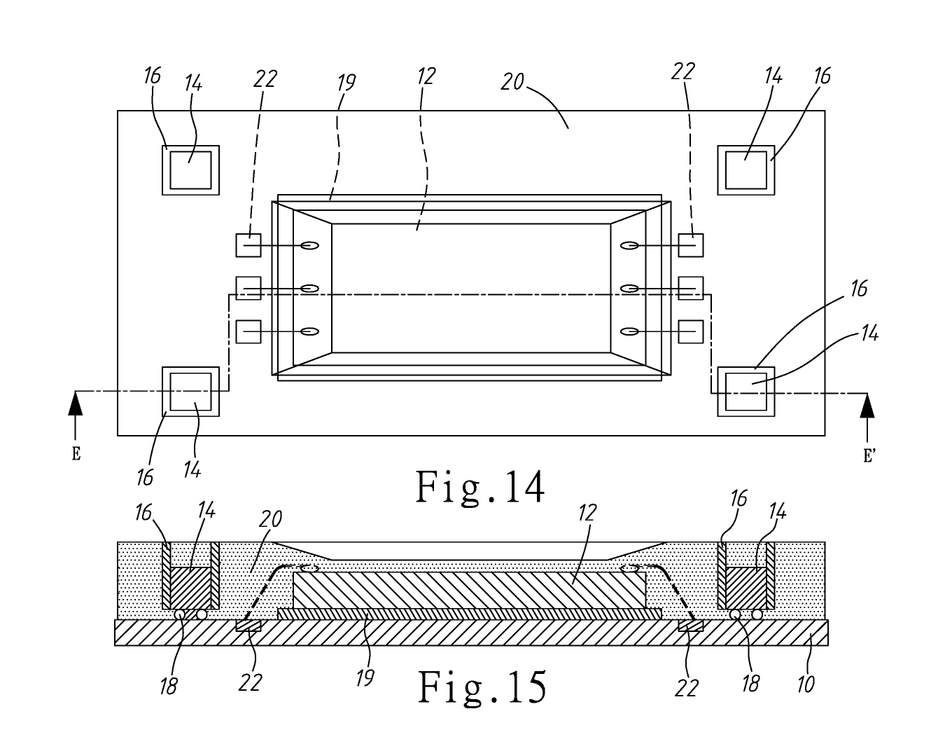

Refer to FIG. 13, FIG. 14 and FIG. 15. The fifth embodiment of the optical fingerprint sensor package of the present invention is introduced as below. The fifth embodiment is different from the first embodiment in the heights of the LED 14 and the non light-transmitting compound 16. In the first embodiment, a top surface of the non light-transmitting compound 16 is level with that of the LED 14. In the fifth embodiment, the top surface of the non light-transmitting compound 16 is higher than that of the LED 14, so that the light-transmitting compound 20 covers the LEDs 14. Compared with the first embodiment, the fifth embodiment more effectively blocks the side light of the LEDs 14 to avoid interfering with the image sensor 12.

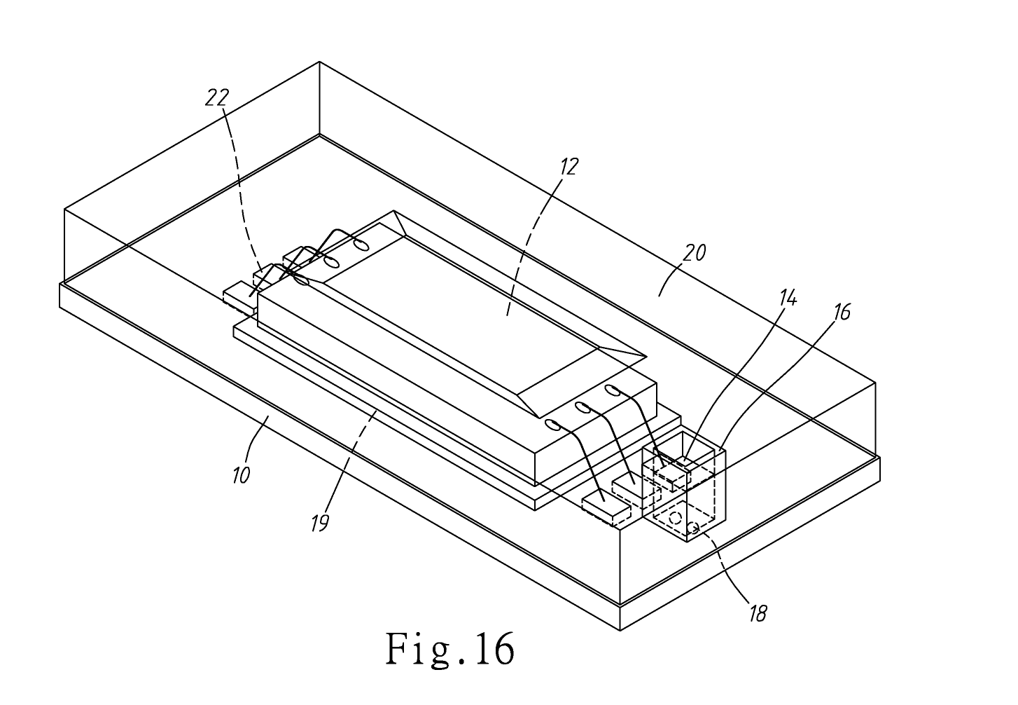

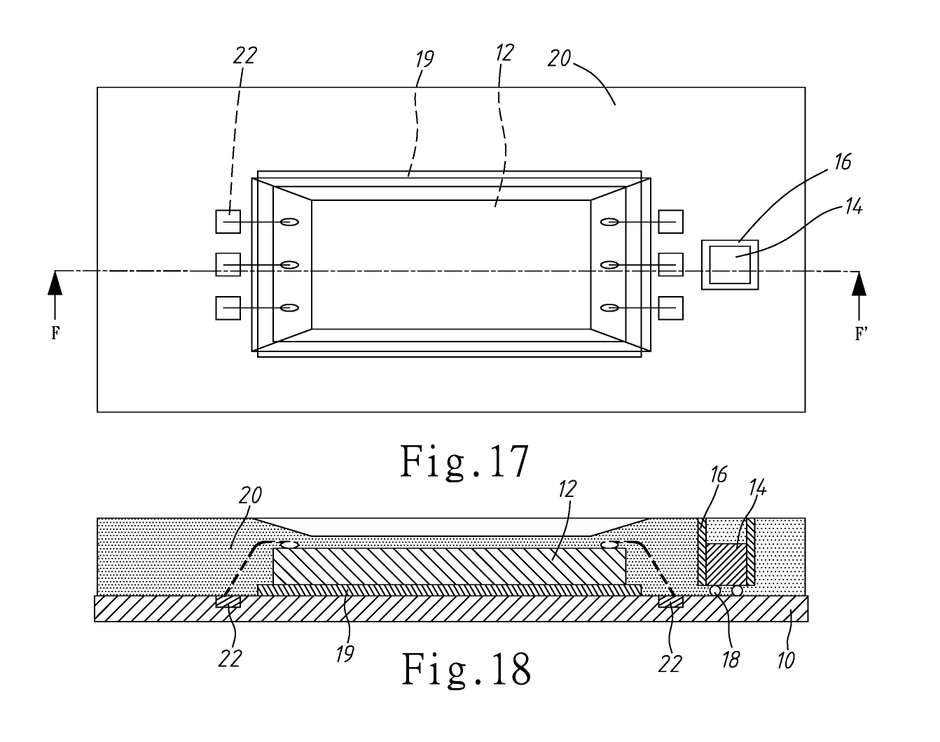

Refer to FIG. 16, FIG. 17 and FIG. 18. The sixth embodiment of the optical fingerprint sensor package of the present invention is introduced as below. The sixth embodiment is different from the second embodiment in the heights of the LED 14 and the non light-transmitting compound 16. In the second embodiment, a top surface of the non light-transmitting compound 16 is level with that of the LED 14. In the sixth embodiment, the top surface of the non light-transmitting compound 16 is higher than that of the LED 14, so that the light-transmitting compound 20 covers the LED 14. Compared with the second embodiment, the sixth embodiment more effectively blocks the side light of the LED 14 to avoid interfering with the image sensor 12.

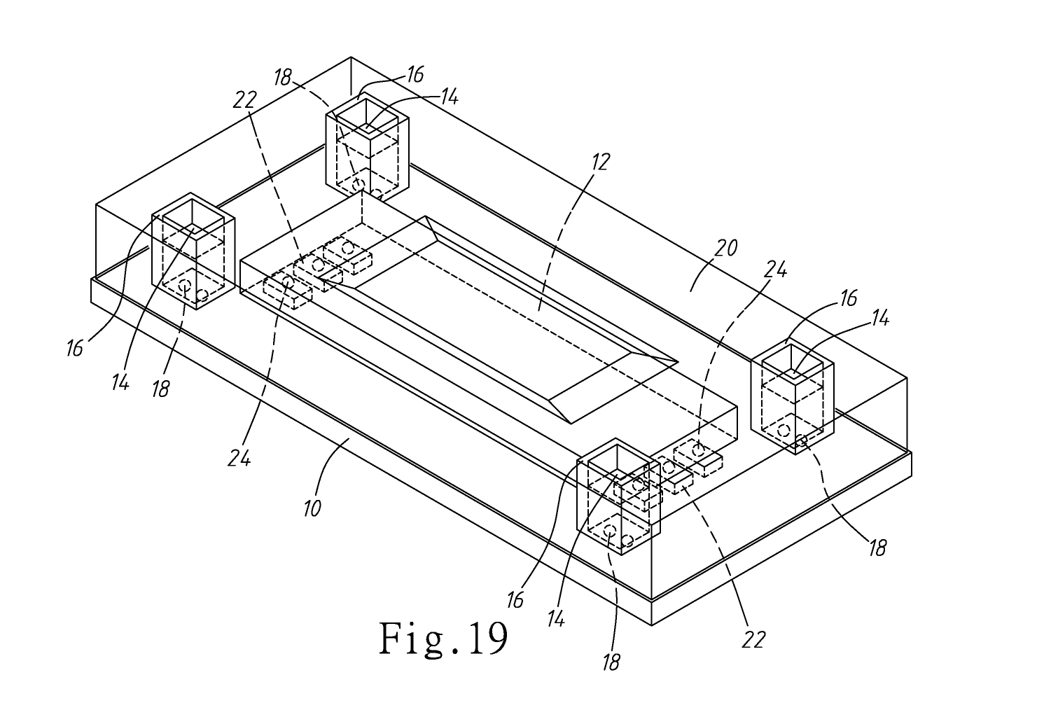

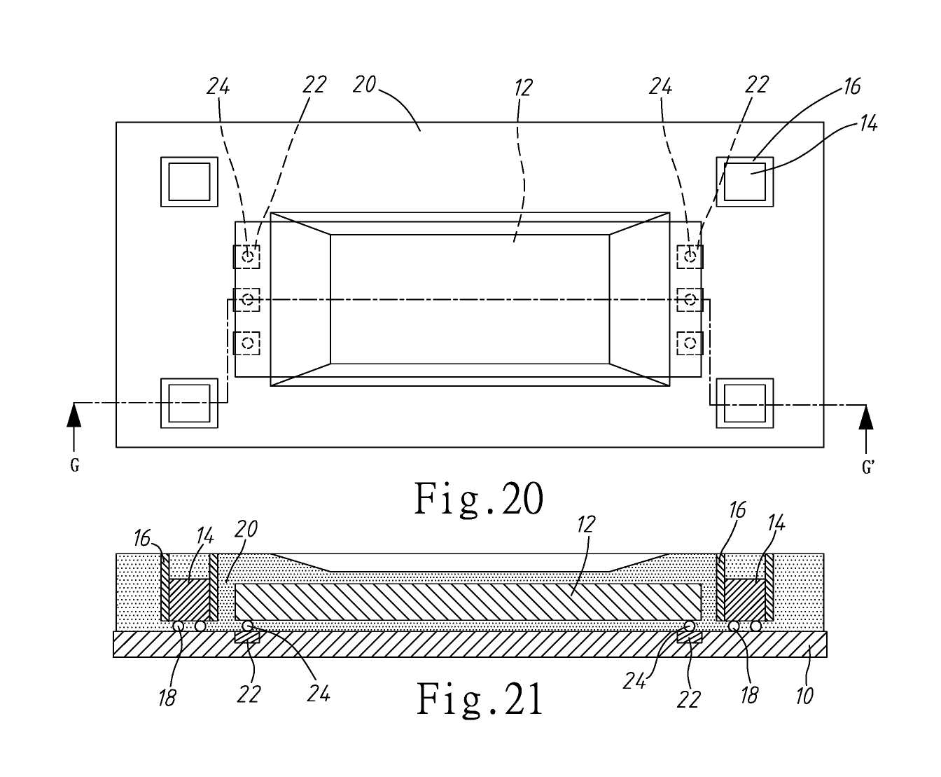

Refer to FIG. 19, FIG. 20 and FIG. 21. The seventh embodiment of the optical fingerprint sensor package of the present invention is introduced as below. The seventh embodiment is different from the third embodiment in the heights of the LED 14 and the non light-transmitting compound 16. In the third embodiment, a top surface of the non light-transmitting compound 16 is level with that of the LED 14. In the seventh embodiment, the top surface of the non light-transmitting compound 16 is higher than that of the LED 14, so that the light-transmitting compound 20 covers the LEDs 14. Compared with the third embodiment, the seventh embodiment more effectively blocks the side light of the LEDs 14 to avoid interfering with the image sensor 12.

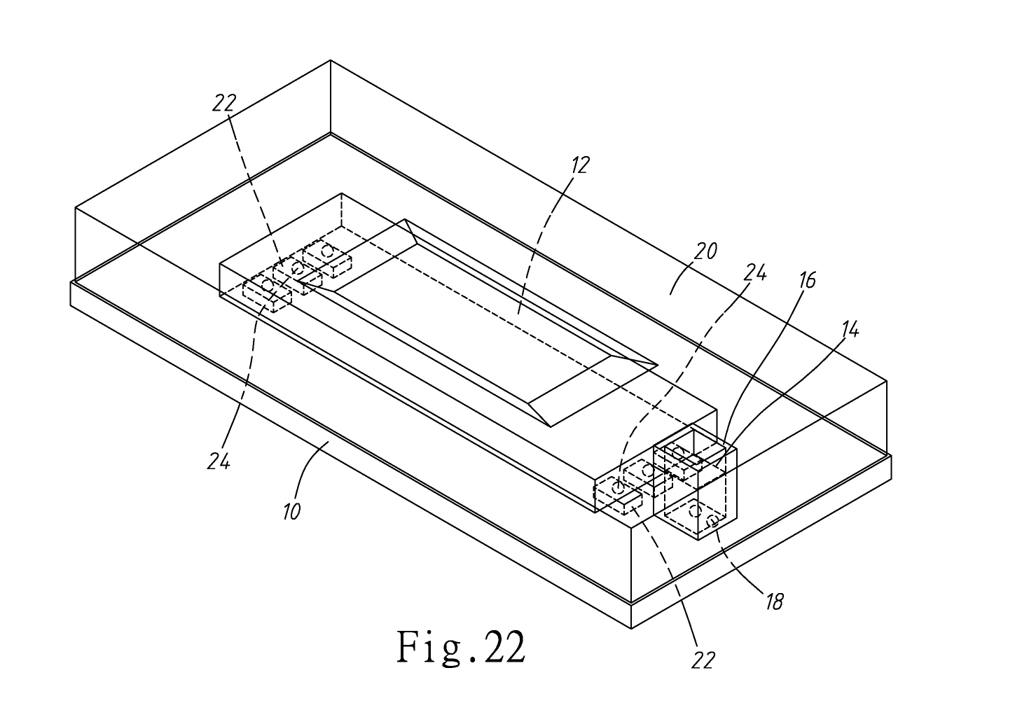

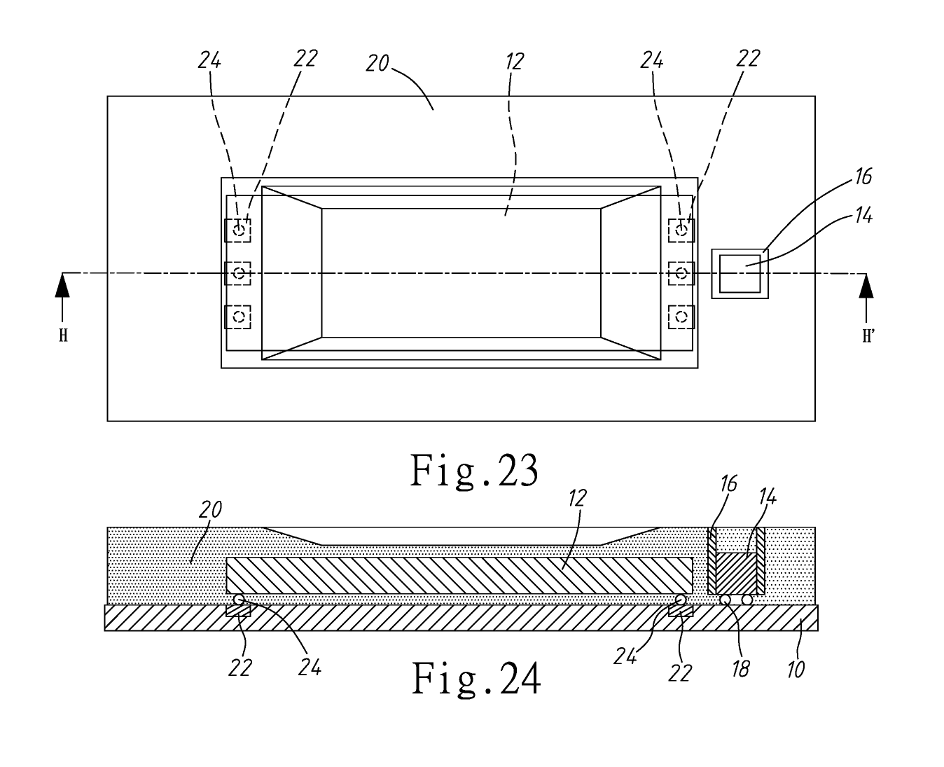

Refer to FIG. 22, FIG. 23 and FIG. 24. The eighth embodiment of the optical fingerprint sensor package of the present invention is introduced as below. The eighth embodiment is different from the fourth embodiment in the heights of the LED 14 and the non light-transmitting compound 16. In the fourth embodiment, a top surface of the non light-transmitting compound 16 is level with that of the LED 14. In the eighth embodiment, the top surface of the non light-transmitting compound 16 is higher than that of the LED 14, so that the light-transmitting compound 20 covers the LED 14. Compared with the fourth embodiment, the eighth embodiment more effectively blocks the side light of the LED 14 to avoid interfering with the image sensor 12.

In conclusion, the present invention uses the non light-transmitting compound to surround the LED and effectively prevents the side light of the LED from interfering with the image sensor in a low-cost manner, thereby improving the precision of the image sensor.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An optical fingerprint recognition sensor package comprising:
a carrier provided with pads thereon;
at least one image sensor mounted on said carrier and electrically connected with said pads;
at least one LED flip-chip mounted on said carrier through first solder bumps and mounted at an outer side of said at least one image sensor; and
at least one non light-transmitting compound surrounding a sidewall of said at least one LED to expose a top surface of said at least one LED.

2. The optical fingerprint sensor package according to claim 1, wherein said at least one image sensor is flip-chip mounted on said carrier and electrically connected with said pads through second solder bumps.

3. The optical fingerprint sensor package according to claim 2, further comprising a light-transmitting compound covering said carrier, said pads, said at least one image sensor, said first solder bumps, said second solder bumps and said at least one non light-transmitting compound.

4. The optical fingerprint sensor package according to claim 1, wherein said at least one image sensor is mounted on said carrier through a die attaching material and electrically connected with said pads by conductive wire bonding.

5. The optical fingerprint sensor package according to claim 4, further comprising a light-transmitting compound covering said carrier, said pads, said at least one image sensor, said die attaching material, said first solder bumps and said at least one non light-transmitting compound.

6. The optical fingerprint sensor package according to claim 1, wherein said carrier is a substrate or a lead frame.

7. The optical fingerprint sensor package according to claim 1, wherein said at least one LED comprises a plurality of LEDs, and said plurality of LEDs is peripherally around said at least one image sensor, and said at least one non-transparent compound comprises a plurality of non-transparent compounds, and said plurality of non-transparent compounds respectively surround said plurality of LEDs.

8. The optical fingerprint sensor package according to claim 1, wherein said at least one LED is an infrared (IR) LED.

9. The optical fingerprint sensor package according to claim 1, wherein a top surface of said at least one non light-transmitting compound is higher than that of said at least one LED.
